(19) United States
(12) Patent Application Publication
(10) Pub. No.: US 2026/0366265 A1
(43) Pub. Date: Nov. 19, 2026

(54) HYDRAULIC CONTROL DEVICE, CONSTRUCTION MACHINE, AND CONTROL METHOD FOR CONSTRUCTION MACHINE

(71) Applicants: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(72) Inventors: Naoki SUGANO, Kobe-shi (JP); Mitsunori HIROZAWA, Hiroshima (JP)

(73) Assignees: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(21) Appl. No.: 19/515,852

(22) PCT Filed: Oct. 1, 2024
(86) PCT No.: PCT/JP2024/035169

§ 371 Date: Mar. 3, 2026

(30) Foreign Application Priority Data
Oct. 18, 2023 (JP) 2023-179530

(51) Int. Cl. E02F 9/22; E02F 9/20; F02D 29/04; F15B 15/18

(52) U.S. Cl. CPC E02F 9/2246; E02F 9/2004; E02F 9/2066; E02F 9/2203; E02F 9/2217; F02D 29/04; F15B 15/18; E02F 9/2029; E02F 9/2285; E02F 9/2296; F02D 2200/60

(57) ABSTRACT

A construction machine includes a work device, at least one actuator that operates the work device, a pump device that supplies hydraulic oil to the at least one actuator, and an engine that drives the pump device. A hydraulic control device includes a manipulation device that receives manipulation for operating the work device, and a controller. The controller performs engine rotation speed control including heavy load control for adjusting an engine rotation speed to a predetermined base rotation speed when work by the construction machine is predetermined heavy load work, and light load control for making the engine rotation speed be higher than the base rotation speed when the work by the construction machine is predetermined light load work.

### TECHNICAL FIELD

The present disclosure relates to a hydraulic control device, a construction machine, and a control method for a construction machine.

### BACKGROUND ART

Each of Patent Literatures 1 to 3 discloses a technique for controlling a rotation speed of an engine in a construction machine. In the technique described in Patent Literature 1, the rotation speed of the engine is increased or decreased on the basis of a manipulation amount of a manipulation member. In the technique described in Patent Literature 2, an extent of reduction in a second target engine rotation speed with respect to a first target engine rotation speed is set according to a type of a hydraulic actuator manipulated by a manipulation lever or a combination of a plurality of hydraulic actuators operated by the manipulation lever. In the technique described in Patent Literature 3, when an engine torque becomes equal to or smaller than a first engine torque and no large engine torque is required, control is performed to lower the engine rotation speed.

Furthermore, Patent Literature 4 discloses a technique for improving fuel efficiency. In the technique described in Patent Literature 4, in a case where an operation direction of a boom cylinder includes a direction component on which positional energy of the boom cylinder acts, and a regeneration condition that an arm performs predetermined high load operation is satisfied, hydraulic oil is supplied from the boom cylinder to an arm cylinder.

However, the techniques described in Patent Literatures 1 to 4 have a problem that it is not possible to achieve both of securing a workload in light load works such as leveling work and soil discharging work and improving fuel efficiency in heavy load works such as excavation work and lifting and slewing work. Specifically, the problem is as follows.

In the technique recited in Patent Literature 1, since the rotation speed of the engine is increased or decreased on the basis of the manipulation amount of the manipulation member, when a manipulation amount of manipulation received by the manipulation member in each of the light load work and the heavy load work is the same, the rotation speed of the engine is adjusted in the same manner regardless of a load of work. In this case, it may be impossible to improve fuel efficiency in the heavy load work while securing a workload in the light load work.

In the technique recited in Patent Literature 2, the rotation speed of the engine is adjusted according to a type of an actuator manipulated by the manipulation member (manipulation lever). However, for example, in each of the leveling work (light load work) and the excavation work (heavy load work), an operator gives arm pulling manipulation to the manipulation member. That is, the manipulation member may receive the same manipulation in both the light load work and the heavy load work. In the technique recited in Patent Literature 2, in a case where manipulation received by the manipulation member is the same (e.g., in a case where the manipulation member receives the arm pulling manipulation), the rotation speed of the engine is adjusted in the same manner regardless of a load of work. Therefore, there is a case where fuel efficiency cannot be improved in heavy load work while a workload is secured in light load work.

In the technique recited in Patent Literature 3, the engine rotation speed is controlled so that the engine rotation speed becomes high in heavy load works such as excavation work and the engine rotation speed becomes low in light load work such as leveling work. Therefore, it is not possible to improve fuel efficiency in the heavy load work while securing a workload in the light load work.

In the technique recited in Patent Literature 4, although fuel efficiency can be improved in a case where the arm performs predetermined high load operation, Patent Literature 4 does not recite securing a workload in light load work.

### CITATION LIST

### Patent Literature

Patent Literature 1: JP 2018-188827 A
Patent Literature 2: WO 2011/096382 A
Patent Literature 3: WO 2009/104636 A
Patent Literature 4: JP 2010-190261 A

### SUMMARY OF INVENTION

An object of the present disclosure is to provide a hydraulic control device, a construction machine, and a control method for a construction machine that enable improvement of fuel efficiency in heavy load work and securing of a workload in light load work.

A hydraulic control device according to a first aspect is a hydraulic control device for a construction machine including a work device, at least one actuator that operates the work device, a pump device that supplies hydraulic oil to the at least one actuator, and an engine that drives the pump device, the hydraulic control device including a manipulation device that receives manipulation for operating the work device, and a controller. The controller performs engine rotation speed control including heavy load control of adjusting an engine rotation speed to a predetermined base rotation speed when work by the construction machine is predetermined heavy load work, and light load control of making the engine rotation speed be higher than the base rotation speed when the work by the construction machine is predetermined light load work.

### BRIEF DESCRIPTION OF DRAWINGS

FIG. 1 is a side view illustrating an example of a construction machine according to an embodiment of the present disclosure.

FIG. 2 is a diagram illustrating an example of a hydraulic circuit of the construction machine.

FIG. 3 is a view for explaining operation of a work device in excavation work.

FIG. 4 is a view for explaining operation of the work device in horizontal pulling work.

FIG. 5 is a view for explaining operation of the work device in pressing and leveling work.

FIG. 6 is a flowchart showing arithmetic processing performed by a controller of a hydraulic control device according to the embodiment of the present disclosure.

FIG. 7 is a graph illustrating a relationship between a manipulation amount and a pump capacity in positive control.

FIG. 8 is a graph illustrating a relationship between a pump pressure and a pump capacity in horsepower control.

FIG. 9 is a graph illustrating an example of engine rotation speed control performed by the controller.

FIG. 10 is a diagram illustrating an example of a map showing a relationship between a manipulation amount and an engine rotation speed in light load control of the engine rotation speed control.

FIG. 11 is a graph illustrating a relationship between the engine rotation speed and a horsepower control torque (PQ control torque).

FIG. 12 is a graph illustrating a torque characteristic in the horsepower control and an engine torque characteristic.

FIG. 13 is a graph illustrating an example of a temporal change in a manipulation amount of arm pulling manipulation received by a manipulation device in each of horizontal pulling and leveling work and the excavation work.

FIG. 14 is a graph illustrating an example of a temporal change in a pump pressure in each of the horizontal pulling and leveling work and the excavation work.

FIG. 15 is a graph illustrating an example of a temporal change in a pump flow rate in the horizontal pulling and leveling work.

FIG. 16 is a graph illustrating an example of a relationship between a pump pressure and a pump capacity in the excavation work.

FIG. 17 is a graph illustrating an example of a temporal change of the pump capacity in the excavation work.

FIG. 18 is a graph illustrating an example of a temporal change of a pump flow rate in the excavation work.

### DESCRIPTION OF EMBODIMENTS

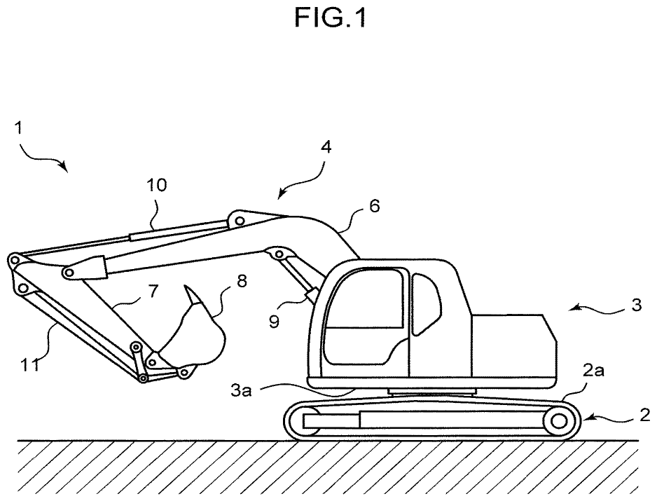

An embodiment of the present disclosure will be described with reference to the drawings. FIG. 1 is a side view illustrating an example of a construction machine 1 according to the present embodiment. Although the construction machine 1 illustrated in FIG. 1 is a hydraulic excavator, the construction machine in the present disclosure is not limited to a hydraulic excavator, and may be another construction machine such as a crane or a bulldozer.

The construction machine 1 includes a lower travelling body 2, an upper slewing body 3 supported on the lower travelling body 2 so as to be slewable, and a work device 4 supported on the upper slewing body 3 so as to move up and down. Although the lower travelling body 2 has a crawler 2a, it may include tires (not illustrated). The upper slewing body 3 has a slewing frame 3a supported by the lower travelling body 2, a cab disposed on the slewing frame 3a, and a counter weight. The work device 4 includes a boom 6, an arm 7 rotatably attached to a distal end of the boom 6, and a bucket 8 rotatably attached to a distal end of the arm 7. The boom 6 is an example of a first movable part in the present disclosure, and the arm 7 is an example of a second movable part in the present disclosure.

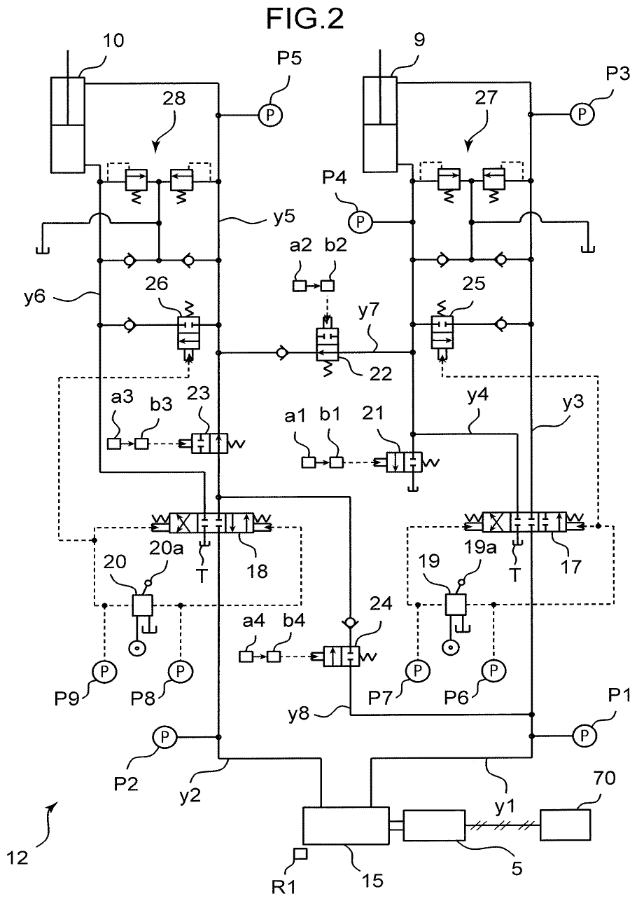

FIG. 2 is a diagram illustrating an example of a hydraulic circuit 12 of the construction machine 1. As illustrated in FIGS. 1 and 2, the construction machine 1 includes a plurality of actuators that cause the work device 4 to operate, a manipulation device that receives manipulation for causing the work device 4 to operate, a pump device 15 that supplies hydraulic oil to the plurality of actuators, an engine 5 that drives the pump device 15, a plurality of valves, and a controller 70. The hydraulic control device according to the present embodiment includes the manipulation device and the controller 70.

In the present embodiment, the plurality of actuators include a boom cylinder 9, an arm cylinder 10, a bucket cylinder 11, a slewing motor (not illustrated), and a travelling motor (not illustrated). The boom cylinder 9 is an example of a first actuator in the present disclosure, and the arm cylinder 10 is an example of a second actuator in the present disclosure.

The boom 6 performs up-down operation of moving up and down with respect to the upper slewing body 3 along with telescopic operation of the boom cylinder 9. Specifically, when the boom cylinder 9 contracts, the boom 6 performs boom lowering operation in which the distal end of the boom 6 approaches the ground. When the boom cylinder 9 extends, the boom 6 performs boom raising operation in which the distal end of the boom 6 moves away from the ground.

The arm 7 performs rotation operation of rotating with respect to the boom 6 along with telescopic operation of the arm cylinder 10. Specifically, when the arm cylinder 10 contracts, the arm 7 performs arm pushing operation in which the distal end of the arm 7 moves away from the boom 6. When the arm cylinder 10 extends, the arm 7 performs arm pulling operation in which the distal end of the arm 7 approaches the boom 6.

The bucket 8 performs rotation operation of rotating with respect to the arm 7 along with telescopic operation of the bucket cylinder 11. Specifically, when the bucket cylinder 11 contracts, the bucket 8 performs bucket soil discharging operation (bucket pushing operation). The bucket soil discharging operation is, for example, operation for discharging a holding object such as earth and sand held by the bucket 8 to a soil discharging destination such as a cargo bed of a truck. When the bucket cylinder 11 extends, the bucket 8 performs bucket excavation operation (bucket pulling operation). The bucket excavation operation is, for example, operation of excavating an excavation target such as ground using the bucket 8.

The upper slewing body 3 performs slewing operation (rightward slewing operation or leftward slewing operation) of slewing around a vertical axis with respect to the lower travelling body 2 along with operation of the slewing motor. The lower travelling body 2 performs travelling operation along with operation of the travelling motor.

The manipulation device includes a plurality of manipulation members that receive various manipulations by the operator. Specifically, for example, the plurality of manipulation members may include a boom manipulation member 19a, an arm manipulation member 20a, a bucket manipulation member (not illustrated), a slewing manipulation member (not illustrated), and a travelling manipulation member (not illustrated). Each of the plurality of manipulation members may be a manipulation lever or a manipulation pedal.

The boom manipulation member 19a receives boom lowering manipulation and boom raising manipulation by the operator. The boom lowering manipulation is manipulation for causing the boom 6 to perform the boom lowering operation and the boom raising manipulation is manipulation for causing the boom 6 to perform the boom raising operation. The arm manipulation member 20a receives arm pushing manipulation and arm pulling manipulation by the operator. The arm pushing manipulation is manipulation for causing the arm 7 to perform the arm pushing operation and the arm pulling manipulation is manipulation for causing the arm 7 to perform the arm pulling operation. The bucket manipulation member receives bucket soil discharging manipulation and bucket excavation manipulation by the operator. The bucket soil discharging manipulation is manipulation for causing the bucket 8 to perform the bucket soil discharging operation, and the bucket excavation manipulation is manipulation for causing the bucket 8 to perform the bucket excavation operation. The slewing manipulation member receives rightward slewing manipulation and leftward slewing manipulation by the operator. The rightward slewing manipulation is manipulation for causing the upper slewing body 3 to perform the rightward slewing operation, and the leftward slewing manipulation is manipulation for causing the upper slewing body 3 to perform the leftward slewing operation. The travelling manipulation member receives travelling manipulation by the operator for causing the lower travelling body 2 to travel.

The construction machine 1 includes a plurality of manipulation detectors. The plurality of manipulation detectors may include a boom manipulation detector, an arm manipulation detector, a bucket manipulation detector, a slewing manipulation detector, and a travelling manipulation detector. The boom manipulation detector detects a manipulation amount of the boom lowering manipulation and a manipulation amount of the boom raising manipulation received by the boom manipulation member 19a. The arm manipulation detector detects a manipulation amount of the arm pushing manipulation and a manipulation amount of the arm pulling manipulation received by the arm manipulation member 20a. The bucket manipulation detector detects a manipulation amount of the bucket soil discharging manipulation and a manipulation amount of the bucket excavation manipulation received by the bucket manipulation member. The slewing manipulation detector detects a manipulation amount of the rightward slewing manipulation and a manipulation amount of the leftward slewing manipulation received by the slewing manipulation member. The travelling manipulation detector detects a manipulation amount of the travelling manipulation received by the travelling manipulation member. Each of the plurality of manipulation detectors inputs a detection result to the controller 70.

The construction machine 1 may include a remote control valve that outputs a pilot pressure (secondary pressure) according to a manipulation amount of manipulation received by the manipulation device. In this case, each of the plurality of manipulation detectors may be a pressure sensor that detects a pilot pressure according to the manipulation amount of the manipulation. Specifically, as illustrated in FIG. 2, the construction machine 1 may include a remote control valve 19 that outputs a pilot pressure according to a manipulation amount of manipulation received by the boom manipulation member 19a, and a remote control valve 20 that outputs a pilot pressure according to a manipulation amount of manipulation received by the arm manipulation member 20a. In this case, the boom manipulation detector may include a pressure sensor P6 that detects a pilot pressure output from the remote control valve 19 according to a manipulation amount of the boom lowering manipulation, and a pressure sensor P7 that detects a pilot pressure output from the remote control valve 19 according to a manipulation amount of the boom raising manipulation. Similarly, the arm manipulation detector may include a pressure sensor P8 that detects a pilot pressure output from the remote control valve 20 according to a manipulation amount of the arm pushing manipulation, and a pressure sensor P9 that detects a pilot pressure output from the remote control valve 20 according to a manipulation amount of the arm pulling manipulation.

Although not illustrated, the bucket manipulation detector may include a pressure sensor that detects a pilot pressure output from the remote control valve according to a manipulation amount of the bucket soil discharging manipulation, and a pressure sensor that detects a pilot pressure output from the remote control valve according to a manipulation amount of the bucket excavation manipulation. Similarly, the slewing manipulation detector may include a pressure sensor that detects a pilot pressure output from the remote control valve according to a manipulation amount of the rightward slewing manipulation, and a pressure sensor that detects a pilot pressure output from the remote control valve according to a manipulation amount of the leftward slewing manipulation. The travelling manipulation detector may include a pressure sensor that detects a pilot pressure output from the remote control valve according to a manipulation amount of the travelling manipulation.

Note that the construction machine 1 may not include the remote control valve. In this case, the plurality of manipulation detectors may be configured to detect a manipulation amount of manipulation (e.g., a manipulation angle of a manipulation lever) received by the plurality of manipulation members, and input a detection result to the controller 70.

The pump device 15 includes at least one hydraulic pump that supplies the hydraulic oil to at least one of the plurality of actuators. Although the pump device may include only one hydraulic pump, the pump device may include a plurality of hydraulic pumps (e.g., two hydraulic pumps). The pump device 15 is driven by the engine 5 to discharge the hydraulic oil. In other words, the at least one hydraulic pump of the pump device 15 discharges the hydraulic oil by being driven by the engine 5.

In the present embodiment, the pump device 15 is a variable displacement hydraulic pump device. In other words, the at least one hydraulic pump of the pump device 15 is a variable displacement hydraulic pump. The construction machine 1 includes a regulator R1 for changing a pump capacity of the pump device 15. The pump capacity of the pump device 15 is adjusted to a magnitude according to a pump capacity command input from the controller 70 to the regulator R1. In a case where the pump device 15 includes the plurality of hydraulic pumps, the pump capacity of the pump device 15 may be a sum of the pump capacities of the plurality of hydraulic pumps. A flow rate of the hydraulic oil discharged from the pump device 15 is referred to as a pump flow rate. In a case where the pump device 15 includes the plurality of hydraulic pumps, a pump flow rate of the pump device 15 may be a sum of the flow rates of the hydraulic oil discharged from the plurality of hydraulic pumps.

The engine 5 is configured to be able to change an engine rotation speed in response to an engine rotation speed command from the controller 70. For example, the engine 5 may be configured to be adjusted to a plurality of rotation speeds according to the engine rotation speed command in a stepwise manner. In the present embodiment, the controller 70 is configured to be able to perform control to adjust the engine rotation speed to a plurality of predetermined levels including a base rotation speed N1 and a standard rotation speed N2. The base rotation speed N1 is a rotation speed lower than the standard rotation speed N2.

The plurality of valves include a plurality of direction switching valves. The plurality of direction switching valves includes a first direction switching valve 17 and a second direction switching valve 18. The first direction switching valve 17 is interposed between the pump device 15 and the boom cylinder 9, and switches a direction in which the hydraulic oil discharged from the pump device 15 is supplied to the boom cylinder 9. The second direction switching valve 18 is interposed between the pump device 15 and the arm cylinder 10, and switches a direction in which the hydraulic oil discharged from the pump device 15 is supplied to the arm cylinder 10. Specifically, the first direction switching valve 17 is connected to the pump device 15 via an oil passage y1, connected to a rod side chamber of the boom cylinder 9 via an oil passage y3, and connected to a head side chamber of the boom cylinder 9 via an oil passage y4. The second direction switching valve 18 is connected to the pump device 15 via an oil passage y2, connected to a rod side chamber of the arm cylinder 10 via an oil passage y5, and connected to a head side chamber of the arm cylinder 10 via an oil passage y6.

The first direction switching valve 17 is configured to be switchable among a neutral position at which the pump device 15 and a tank T are blocked from the boom cylinder 9, a position (a right position in FIG. 2) at which the oil passage y1 and the oil passage y3 are connected and the oil passage y4 and the tank T are blocked from each other, and a position (a left position in FIG. 2) at which the oil passage y1 and the oil passage y4 are connected and the oil passage y3 and the tank T are connected. The first direction switching valve 17 is subjected to switching manipulation by the pilot pressure output from the remote control valve 19 according to the manipulation received by the boom manipulation member 19a. Note that a right position of the first direction switching valve 17 may also be configured to connect the oil passage y4 and the tank T.

The second direction switching valve 18 is configured to be switchable among a neutral position where the pump device 15 and the tank T are blocked from the arm cylinder 10, a position (the right position in FIG. 2) where the oil passage y2 and the oil passage y5 are connected and the oil passage y6 and the tank T are connected, and a position (the left position in FIG. 2) where the oil passage y2 and the oil passage y6 arc connected and the oil passage y5 and the tank T are connected. The second direction switching valve 18 is subjected to switching manipulation by the pilot pressure output from the remote control valve 20 according to the manipulation received by the arm manipulation member 20a.

The plurality of direction switching valves further includes a direction switching valve (not illustrated) that switches a direction in which the hydraulic oil discharged from the pump device 15 is supplied to the bucket cylinder 11, a direction switching valve (not illustrated) that switches a direction in which the hydraulic oil discharged from the pump device 15 is supplied to the slewing motor, and a direction switching valve (not illustrated) that switches a direction in which the hydraulic oil discharged from the pump device 15 is supplied to the travelling motor. Since structures and functions of these direction switching valves are similar to those of the first direction switching valve 17, detailed description thereof will be omitted.

The controller 70 has a computer including a processor and a memory. The controller 70 controls operation of the construction machine 1 by execution of a program stored in the memory by the processor. The controller 70 performs engine rotation speed control. The engine rotation speed control includes heavy load control and light load control. Details of the engine rotation speed control will be described later.

The construction machine 1 performs various works at a work site in accordance with manipulations received by the manipulation device. The various works include predetermined heavy load work and predetermined light load work. The predetermined heavy load work includes at least one heavy load work among various heavy load works with heavy loads. The predetermined light load work includes at least one light load work among various light load works with light loads. In the present embodiment, the predetermined heavy load work includes the excavation work and the lifting and slewing work, and the predetermined light load work includes the leveling work and the soil discharging work. However, the predetermined heavy load work in the present disclosure is not limited to the excavation work and the lifting and slewing work, and may include other heavy load work. In addition, the predetermined light load work in the present disclosure is not limited to the leveling work and the soil discharging work, and may include other light load work.

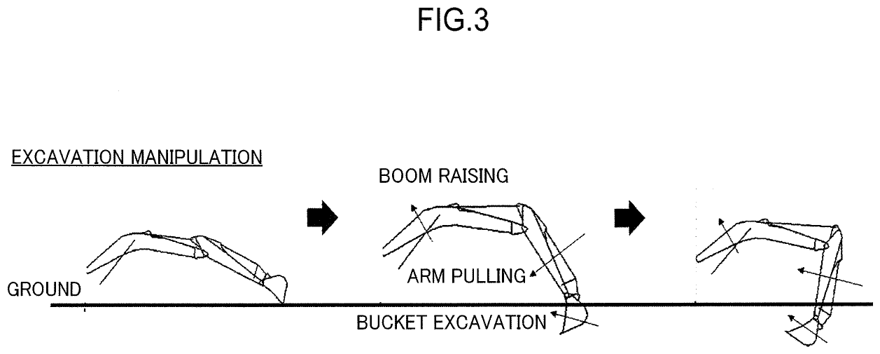

FIG. 3 is a view for explaining operation of the work device 4 in the excavation work. The excavation work is work of excavating an excavation target such as earth and sand of the ground with the bucket 8. When the construction machine 1 performs the excavation work, the manipulation device receives the arm pulling manipulation, the boom raising manipulation, and the bucket excavation manipulation (bucket pulling manipulation) by the operator, the arm 7 performs the arm pulling operation, the boom 6 performs the boom raising operation, and the bucket 8 performs the bucket excavation operation (the bucket pulling operation). In the excavation work, since the arm pulling operation is performed in a state where at least a part of the bucket 8 is disposed in the ground, the load of the excavation work is high.

The lifting and slewing work is work performed mainly after the excavation work and before the soil discharging work. The lifting and slewing work is work performed mainly before the soil discharging work, and is work for moving the bucket 8 to directly above a soil discharging destination such as a cargo bed of a truck by slewing the upper slewing body 3 while raising the bucket 8. When the construction machine 1 performs the lifting and slewing work, the manipulation device receives the boom raising manipulation and the slewing manipulation by the operator, the boom 6 performs the boom raising operation, and the upper slewing body 3 performs the slewing operation. In the lifting and slewing work, it is necessary to rotate the boom 6 in a direction against gravity and to slew the upper slewing body 3. Therefore, the load of the lifting and slewing work is high.

The leveling work is work of leveling a leveling target such as a surface of the ground by the bucket 8. The leveling work may be horizontal pulling and leveling work, horizontal pushing and leveling work, or pressing and leveling work.

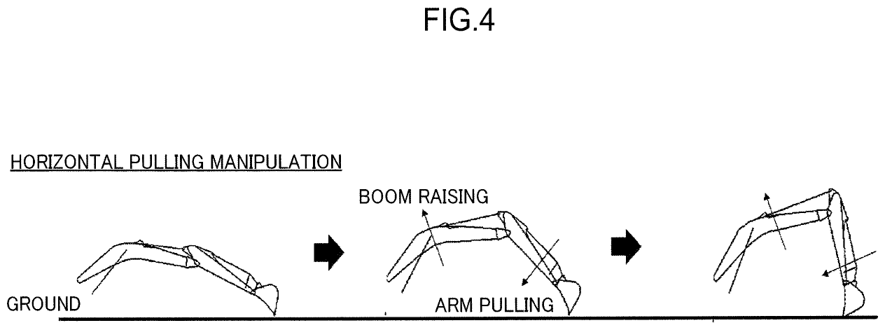

FIG. 4 is a view for explaining operation of the work device 4 in the horizontal pulling and leveling work. The horizontal pulling and leveling work is work of moving a distal end of the bucket 8 in a direction approaching the upper slewing body 3 along the ground. When the construction machine 1 performs the horizontal pulling and leveling work, the manipulation device receives the arm pulling manipulation and the boom raising manipulation by the operator, the arm 7 performs the arm pulling operation, and the boom 6 performs the boom raising operation. In the horizontal pulling and leveling work, a most part of the bucket 8 is disposed above the ground, and the slewing operation of the upper slewing body 3 is not performed. Therefore, a load of the horizontal pulling and leveling work is relatively light.

When the construction machine 1 performs the horizontal pushing and leveling work, the manipulation device receives the arm pushing manipulation and the boom lowering manipulation by the operator, the arm 7 performs the arm pushing operation, and the boom 6 performs the boom lowering operation. In the horizontal pushing and leveling work, a most part of the bucket 8 is disposed above the ground, and the slewing operation of the upper slewing body 3 is not performed. Therefore, a load of the horizontal pushing and leveling work is relatively light.

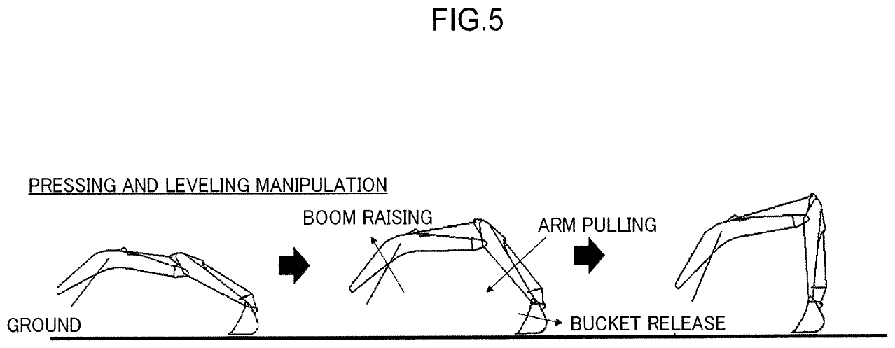

FIG. 5 is a view for explaining operation of the work device 4 in the pressing and leveling work. The pressing and leveling work is work of moving the bucket 8 along the ground while pressing an outer surface (a bottom surface) of the bucket 8 against the ground. The pressing and leveling work may be pressing, pulling and leveling work or pressing, pushing and leveling work.

The pressing, pulling and leveling work is work of moving the bucket 8 in a direction of approaching the upper slewing body 3 along the ground while pressing the outer surface (bottom surface) of the bucket 8 against the ground. When the construction machine 1 performs the pressing, pulling and leveling work, the manipulation device receives the arm pulling manipulation, the boom raising manipulation, and the bucket soil discharging manipulation (the bucket pushing manipulation) by the operator, the arm 7 performs the arm pulling operation, the boom 6 performs the boom raising operation, and the bucket 8 performs the bucket soil discharging operation (the bucket pushing operation). In the pressing, pulling and leveling work, a most part of the bucket 8 is disposed above the ground, and the slewing operation of the upper slewing body 3 is not performed. Therefore, a load of the pressing, pulling and leveling work is relatively low.

The pressing, pushing and leveling work is work of moving the bucket 8 in a direction away from the upper slewing body 3 along the ground while pressing the outer surface (bottom surface) of the bucket 8 against the ground. When the construction machine 1 performs the pressing, pushing and leveling work, the manipulation device receives the arm pushing manipulation, the boom lowering manipulation, and the bucket excavation manipulation (the bucket pulling manipulation) by the operator, the arm 7 performs the arm pushing operation, the boom 6 performs the boom lowering operation, and the bucket 8 performs the bucket excavation operation (the bucket pulling operation). In the pressing, pushing and leveling work, a most part of the bucket 8 is disposed above the ground, and the slewing operation of the upper slewing body 3 is not performed. Therefore, a load of the pressing, pushing and leveling work is relatively low.

The soil discharging work is work of discharging a holding object held by the bucket 8 directly above a soil discharging destination such as a cargo bed of a truck to the soil discharging destination. When the construction machine 1 performs the soil discharging work, the manipulation device receives the bucket soil discharging manipulation by the operator, and the bucket 8 performs the bucket soil discharging operation (the bucket pushing operation). In the soil discharging work, the bucket 8 is disposed above the ground, and the slewing operation of the upper slewing body 3 is not performed. Therefore, a load of the soil discharging work is relatively low.

The controller 70 may determine a type of work by the construction machine 1 (i.e., the work performed by the construction machine 1) using detection results input from the plurality of manipulation detectors. In the controller 70, the excavation work and the lifting and slewing work may be set in advance as the predetermined heavy load work, and the leveling work and the soil discharging work may be set in advance as the predetermined light load work. That is, the controller 70 may be configured to be able to determine whether or not the work by the construction machine 1 is the predetermined heavy load work, i.e., whether or not the work by the construction machine 1 is the excavation work or the lifting and slewing work. The controller 70 may also be configured to be able to determine whether or not the work by the construction machine 1 is the predetermined light load work, i.e., whether or not the work by the construction machine 1 is the leveling work or the soil discharging work. In the excavation work, the manipulation device receives the arm pulling manipulation. In the lifting and slewing work, the manipulation device receives the boom raising manipulation and the slewing manipulation. In the horizontal pulling and leveling work, the manipulation device receives the arm pulling manipulation and the boom raising manipulation. In the pressing, pulling and leveling work, the manipulation device receives the arm pulling manipulation, the boom raising manipulation, and the bucket soil discharging manipulation. In the pressing, pushing and leveling work, the manipulation device receives the arm pushing manipulation, the boom lowering manipulation, and the bucket excavation manipulation. In the soil discharging work, the manipulation device receives the bucket soil discharging manipulation. That is, the detection results input from the plurality of manipulation detectors to the controller 70 serve as an index for the controller 70 to determine a type of work.

### Engine Rotation Speed Control

The engine rotation speed control performed by the controller 70 will be described below. The engine rotation speed control includes the heavy load control for adjusting the engine rotation speed to the predetermined base rotation speed N1 when the work by the construction machine 1 is the predetermined heavy load work, and the light load control for making the engine rotation speed be higher than the base rotation speed NI when the work by the construction machine 1 is the predetermined light load work. By performing the engine rotation speed control, in a case where the work of the construction machine 1 is the predetermined heavy load work, fuel efficiency in the heavy load work can be improved, and in a case where the work of the construction machine 1 is the predetermined light load work, a workload in the light load work can be secured.

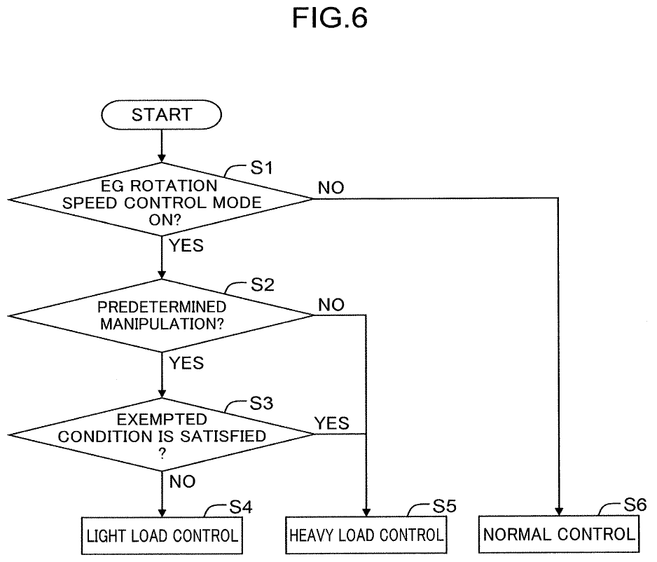

FIG. 6 is a flowchart showing an example of arithmetic processing executed by the controller 70. In step S1, the controller 70 determines whether or not a control mode is an engine rotation speed control mode (EG rotation speed control mode). When the control mode is the engine rotation speed control mode (YES in step S1), the controller 70 performs processing in and after step S2. When the control mode is not the engine rotation speed control mode (NO in step S1), the controller 70 performs normal control (step S6) instead of the processing in and after step S2 (engine rotation speed control). In the present embodiment, the controller 70 adjusts the engine rotation speed to the standard rotation speed N2 in the normal control.

In step S2, the controller 70 determines whether or not predetermined manipulation is performed on the basis of detection results by the plurality of manipulation detectors. The predetermined manipulation is at least one manipulation for determining whether or not the work by the construction machine 1 is the predetermined light load work. That is, the predetermined manipulation is at least one manipulation stored in advance in the controller 70 to determine whether or not to perform the light load control. In the present embodiment, the predetermined manipulation includes the arm pulling manipulation, the arm pushing manipulation, and the bucket soil discharging manipulation. The arm pulling manipulation is manipulation received by the manipulation device in each of the horizontal pulling and leveling work and the pressing, pulling and leveling work. The arm pushing manipulation is manipulation received by the manipulation device in the pressing, pushing and leveling work. The bucket soil discharging manipulation is manipulation received by the manipulation device in the soil discharging work.

In a case where the manipulation device receives the predetermined manipulation (YES in step S2), specifically, in a case where the manipulation device receives at least one of the arm pulling manipulation, the arm pushing manipulation, and the bucket soil discharging manipulation, the controller 70 performs processing of step S3. On the other hand, in a case where the manipulation device does not receive the predetermined manipulation (NO in step S2), the controller 70 performs processing of step S5.

Specifically, for example, in a case where the manipulation by the construction machine 1 is the predetermined light load work (the leveling work or the soil discharging work), the manipulation device receives at least one of the arm pulling manipulation, the arm pushing manipulation, and the bucket soil discharging manipulation (YES in step S2), and thus the controller 70 performs the processing of step S3. In a case where the manipulation by the construction machine 1 is the lifting and slewing work (the predetermined heavy load work), the manipulation device receives the boom raising manipulation and the slewing manipulation, but does not receive the predetermined manipulation (NO in step S2), and thus, the controller 70 performs the processing of step S5. On the other hand, in a case where the manipulation by the construction machine 1 is the excavation work (the predetermined heavy load work), the manipulation device receives the arm pulling manipulation, the boom raising manipulation, and the bucket excavation manipulation (YES in step S2), and thus, the controller 70 performs the processing of step S3.

In step S3, the controller 70 determines whether or not a predetermined exempted condition is satisfied. The exempted condition is a condition set in advance for determining whether or not execution of the light load control should be suspended even when the manipulation device receives the predetermined manipulation. In a case where the exempted condition is not satisfied (NO in step S3), the controller 70 performs the light load control (step S4). As a result, the workload in the predetermined light load work can be secured. On the other hand, in a case where the exempted condition is satisfied (YES in step S3), the controller 70 does not perform the light load control. In the present embodiment, not only a type of manipulation received by the manipulation device but also the exempted condition is used as an index for determining whether or not the work by the construction machine 1 is the predetermined light load work, so that determination accuracy as to whether or not the work by the construction machine 1 is the predetermined light load work (i.e., determination accuracy as to whether or not to execute the light load control) is improved.

In the present embodiment, the exempted condition includes at least one of conditions (a) to (c). The condition (a) is that a load acting on the actuator is equal to or more than a predetermined first set value. The condition (b) is that a pump pressure of the pump device 15 (a pump discharge pressure of the pump device 15) is equal to or more than a predetermined second set value. The condition (c) is that horsepower control (so-called PQ control) is performed.

In a case where at least one of that the load acting on the actuator is equal to or more than the predetermined first set value, that the pump pressure is equal to or more than the predetermined second set value (e.g., equal to or higher than a set pressure Ps to be described later), and that the horsepower control is performed is satisfied, there is a high possibility that the work of the construction machine is heavy load work. Therefore, in the present embodiment, even in a case where the manipulation device receives the predetermined manipulation, when the exempted condition is satisfied as a result of satisfying at least one of the conditions (a) to (c) (YES in step S3), the heavy load control (step S5) is performed instead of the light load control (step S4). This improves fuel efficiency in the heavy load work.

The construction machine 1 may include a load detector for detecting a load acting on the actuator, which is a parameter included in the condition (a). In this case, the load detector inputs a detection result to the controller 70, and the controller 70 determines whether or not the load acting on the actuator is equal to or more than the first set value on the basis of the detection result by the load detector.

The load detector may be, for example, a pressure sensor that detects a pressure acting on at least one of the plurality of actuators. Specifically, the load detector may include at least one of a pressure sensor P3 that detects a pressure acting on the rod side chamber of the boom cylinder 9, a pressure sensor P4 that detects a pressure acting on the head side chamber of the boom cylinder 9, a pressure sensor P5 that detects a pressure acting on the rod side chamber of the arm cylinder 10, and a pressure sensor (not illustrated) that detects a pressure acting on the head side chamber of the arm cylinder 10. In addition, the load detector may include a pressure sensor (not illustrated) that detects a pressure acting on at least one of the bucket cylinder 11, the slewing motor, and the travelling motor.

The construction machine 1 may include a pump pressure detector for detecting a pump pressure that is a parameter included in the condition (b). In this case, the pump pressure detector inputs a detection result to the controller 70, and the controller 70 determines whether or not the pump pressure is equal to or more than the second set value on the basis of the detection result by the pump pressure detector.

The pump pressure detector may include, for example, one or both of a pump pressure sensor P1 and a pump pressure sensor P2. When the pump device 15 includes only one hydraulic pump, in the pump pressure detector, one of the pump pressure sensor P1 and the pump pressure sensor P2 may detect a pump pressure of the hydraulic pump (i.e., the pump pressure of the pump device 15). In this case, the pump pressure detector only needs to include only one of the pump pressure sensor P1 and the pump pressure sensor P2, and the other may be omitted. In a case where the pump device 15 includes, for example, a first hydraulic pump and a second hydraulic pump, the pump pressure sensor P1 may detect a pump pressure of the first hydraulic pump (e.g., a pressure in the oil passage y1), and the pump pressure sensor P2 may detect a pump pressure of the second hydraulic pump (e.g., a pressure in the oil passage y2). In this case, the pump pressure of the pump device 15 may be a value calculated using the pump pressure of the first hydraulic pump and the pump pressure of the second hydraulic pump. Specifically, for example, the pump pressure of the pump device 15 may be a value obtained by arithmetically averaging the pump pressure of the first hydraulic pump and the pump pressure of the second hydraulic pump, may be a value obtained by weighted-averaging the pump pressure of the first hydraulic pump and the pump pressure of the second hydraulic pump, or may be a value calculated by another calculation method.

For example, the controller 70 may determine whether or not to perform the horsepower control on the basis of a detection result by the pump pressure detector (i.e., the pump pressure of the pump device 15). Note that a method other than the method based on the pump pressure may be used to determine whether or not to perform the horsepower control.

Next, the light load control (step S4), the heavy load control (step S5), and the normal control (step S6) will be described. In the normal control, the controller 70 performs control to adjust the engine rotation speed to the standard rotation speed N2 which is a standard engine rotation speed set in advance. In the heavy load control, the controller 70 performs control to adjust the engine rotation speed to the base rotation speed N1 lower than the standard rotation speed N2. In the light load control, the controller 70 performs control to make the engine rotation speed be higher than the base rotation speed N1. Specifically, in the light load control according to the present embodiment, the controller 70 performs control to adjust the engine rotation speed so that the engine rotation speed increases from the base rotation speed N1 according to the manipulation amount of the manipulation.

In addition, in each of the light load control, the heavy load control, and the normal control, the controller 70 performs both positive control and the horsepower control (so-called PQ control) on the pump capacity of the pump device 15.

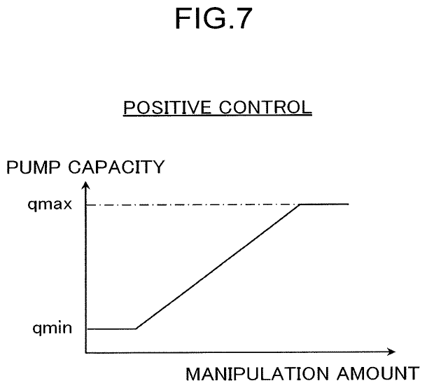

The positive control is control for increasing the pump capacity of the pump device 15 in accordance with an increase in the manipulation amount of the manipulation received by the manipulation device. The controller 70 calculates a pump capacity for the positive control, i.e., a pump capacity corresponding to the manipulation amount of the manipulation received by the manipulation device. In the controller 70, there is set in advance, for example, a characteristic as illustrated in FIG. 7, i.e., a characteristic in which the pump capacity linearly increases from a minimum capacity qmin with a maximum capacity qmax as an upper limit as the manipulation amount increases. The controller 70 calculates a pump capacity for the positive control on the basis of the characteristic and the manipulation amount of the manipulation received by the manipulation device.

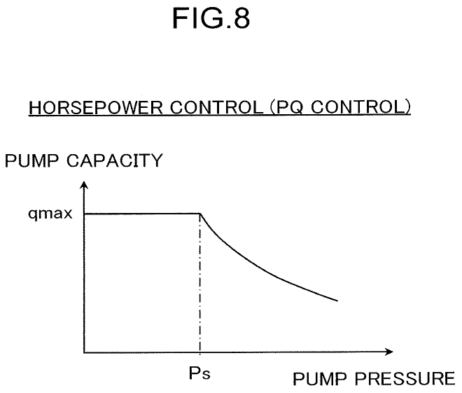

The horsepower control is control to limit a pump horsepower calculated using the pump pressure and the pump capacity of the pump device 15 (a horsepower required to drive the pump device 15) on the basis of a horsepower curve of the engine 5. In the controller 70, for example, a characteristic (horsepower control characteristic) as illustrated in FIG. 8 is set in advance. The horsepower control characteristic is a characteristic that the pump capacity becomes the maximum capacity qmax in a low pressure region where the pump pressure is lower than the set pressure Ps, and the pump capacity decreases from the maximum capacity qmax as the pump pressure increases from the set pressure Ps in a high pressure region (PQ region) where the pump pressure is equal to or higher than the set pressure Ps. The controller 70 calculates a pump capacity for the horsepower control on the basis of the horsepower characteristic and the pump pressure.

The controller 70 compares the pump capacity calculated for the positive control with the pump capacity calculated for the horsepower control, and selects the lower one of these pump capacities (performs low value selection). Then, the controller 70 adjusts an actual pump capacity of the pump device 15 to the pump capacity selected as described above.

In the present embodiment, the pump pressure becomes lower than the set pressure Ps in the predetermined light load work, and the pump pressure becomes equal to or higher than the set pressure Ps in the predetermined heavy load work. Therefore, when the construction machine 1 performs the predetermined light load work, the pump pressure becomes lower than the set pressure Ps, so that the pump capacity calculated for the positive control is selected for a low value. On the other hand, in a case where the construction machine 1 performs the predetermined heavy load work and the manipulation amount of the manipulation received by the manipulation device is the maximum value (in a case of so-called full lever manipulation), the pump capacity calculated for the horsepower control is selected for a low value. Note that even in a case where the construction machine 1 performs the predetermined heavy load work, when the manipulation amount of the manipulation received by the manipulation device is small, the pump capacity calculated for the positive control may be selected for a low value.

Next, the control of the rotation speed of the engine 5 in each of the light load control, the heavy load control, and the normal control will be described.

The controller 70 adjusts the rotation speed of the engine 5 to the standard rotation speed N2 in the normal control (step S6 in FIG. 6). Thus, although in the present embodiment, the engine rotation speed in the normal control is the same as a maximum value (standard rotation speed N2) of the engine rotation speed in the light load control, the engine rotation speed in the normal control is not limited to the standard rotation speed N2, and may be higher than the standard rotation speed N2, or may be a value between the base rotation speed N1 and the standard rotation speed N2.

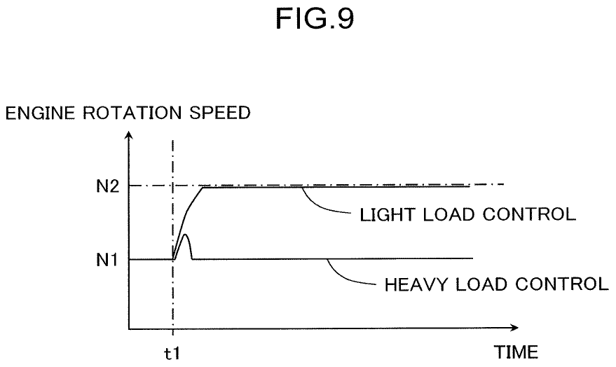

Next, the light load control (step S4) and the heavy load control (step S5) in the engine rotation speed control will be described. FIG. 9 is a graph illustrating an example of the engine rotation speed control performed by the controller 70.

### Light Load Control

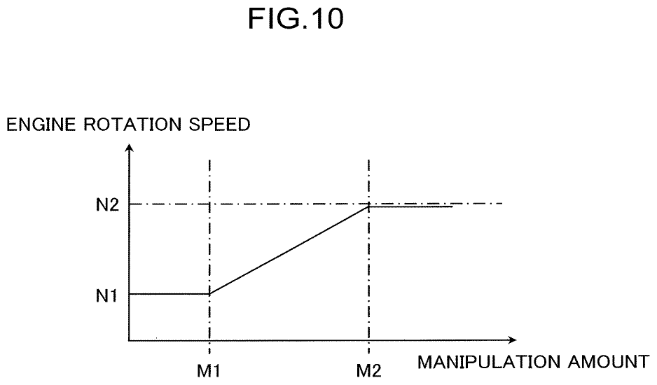

First, the light load control (step S4 in FIG. 6) will be described. For example, in a case where after the predetermined light load work such as the leveling work or the soil discharging work by the construction machine 1 is started, at time t1 in FIG. 9, the controller 70 determines that the exempted condition is not satisfied in step S3 (NO in step S3), the controller 70 performs the light load control (step S4). In the light load control, the controller 70 adjusts the engine rotation speed to a predetermined rotation speed higher than the base rotation speed N1 as illustrated in FIG. 9. In this light load control, the controller 70 may uniformly adjust the engine rotation speed to the standard rotation speed N2 regardless of the manipulation amount of the manipulation, and also may adjust the engine rotation speed according to a map as illustrated in FIG. 10.

FIG. 10 is a diagram illustrating an example of a map showing a relationship between a lever manipulation amount and an engine rotation speed in the light load control of the engine rotation speed control. In the light load control, the controller 70 may adjust the engine rotation speed so that the engine rotation speed increases from the base rotation speed N1 according to the manipulation amount (lever manipulation amount) of the manipulation as illustrated in FIG. 10. In this case, in the light load control, the engine rotation speed can be gradually increased according to the manipulation amount. This enables suppression of occurrence of a sudden change in the engine rotation speed when the light load control is started. This can prevent the work device 4 from performing sudden operation when the light load control is started. In addition, among various light load works, for example, in a light load work in which work efficiency is prioritized, when the manipulation device receives manipulation of a large manipulation amount such as the full lever manipulation, the engine rotation speed has a large value corresponding to the large manipulation amount, so that it is possible to secure a workload of the light load work. On the other hand, among various light load works, for example, in a light load work in which accuracy is prioritized, when the manipulation device receives manipulation of a small manipulation amount such as fine manipulation, the engine rotation speed is suppressed to a low value corresponding to the small manipulation amount, so that it is possible to secure accuracy of the light load work and improve fuel efficiency.

In the present embodiment, a range in which the engine rotation speed is adjusted in the light load control is a range from the base rotation speed NI as the minimum value to the standard rotation speed N2 as the maximum value. The controller 70 adjusts the engine rotation speed so that the engine rotation speed increases as the manipulation amount of the manipulation received by the manipulation device increases. As illustrated in FIG. 10, in a case where the manipulation amount of the manipulation received by the manipulation device is M2 or more, the controller 70 may adjust the engine rotation speed to a constant value (the standard rotation speed N2). As illustrated in FIG. 10, in a case where the manipulation amount of the manipulation received by the manipulation device is M1 or less, the controller 70 may adjust the engine rotation speed to a constant value (the base rotation speed N1).

In a case where the engine rotation speed is adjusted according to the map in the light load control as illustrated in FIG. 10, the “manipulation amount” which is a parameter on a horizontal axis in FIG. 10 is the manipulation amount of the manipulation received by the manipulation device in the work by the construction machine 1. In a case where the manipulation device simultaneously receives a plurality of manipulations in the work by the construction machine 1, the parameter may be a manipulation amount of any predetermined manipulation among the plurality of manipulations, or may be the largest manipulation amount among the manipulation amounts of the plurality of manipulations.

Specifically, for example, in a case where the work by the construction machine 1 is the horizontal pulling and leveling work, the manipulation device receives the arm pulling manipulation and the boom raising manipulation. Therefore, the parameter may be a manipulation amount of the arm pulling manipulation, a manipulation amount of the boom raising manipulation, or a larger one of the manipulation amount of the arm pulling manipulation and the manipulation amount of the boom raising manipulation. In a case where the work by the construction machine 1 is the pressing, pulling and leveling work, the manipulation device receives the arm pulling manipulation, the boom raising manipulation, and the bucket soil discharging manipulation (the bucket pushing manipulation). Therefore, the parameter may be the manipulation amount of the arm pulling manipulation, the manipulation amount of the boom raising manipulation, a manipulation amount of the bucket soil discharging manipulation, or the largest manipulation amount among the manipulation amounts of these manipulations.

In a case where the work by the construction machine 1 is the predetermined light load work, the pump pressure becomes lower than the set pressure Ps, and thus the pump capacity calculated for the positive control is selected for a low value. That is, in this case, the controller 70 performs the positive control instead of the horsepower control. In this case, a pump flow rate Q, which is a flow rate of the hydraulic oil discharged from the pump device 15, can be expressed by the following equation (1).

Pump flow rate Q=pump capacity q×engine rotation speed N (1)

In addition, in a case where the work by the construction machine 1 is the predetermined light load work such as the leveling work or the soil discharging work, the exempted condition is not satisfied. Then, in a case where the manipulation received by the manipulation device in the light load work is the full lever manipulation, i.e., when the manipulation amount is the maximum manipulation amount, the pump capacity becomes the maximum capacity qmax as illustrated in FIG. 7, and the engine rotation speed N increases to the standard rotation speed N2 as illustrated in FIG. 10. As a result, a sufficient pump flow rate Q (=qmax×N2) is secured. Thus, the workload can be secured in the predetermined light load work.

### Heavy Load Control

Next, the heavy load control will be described. For example, the predetermined heavy load work such as the excavation work or the lifting and slewing work by the construction machine 1 is started, and at the time t1 in FIG. 9, in a case where the controller 70 does not receive the predetermined manipulation in step S2 (NO in step S2), or in a case where the exempted condition is satisfied in step S3 (YES in step S3), the controller 70 performs the heavy load control (step S5). In this heavy load control, the controller 70 adjusts the engine rotation speed to the base rotation speed N1 as illustrated in FIG. 9. Note that at an initial stage (immediately after the time t1 in FIG. 9) when the heavy load control is started, the engine rotation speed may be temporarily higher than the base rotation speed N1. This is because the exempted condition may not be satisfied due to the pump pressure being lower than Ps at the initial stage, and therefore, the processing of step S4 may be temporarily performed at this initial stage.

In a case where the work by the construction machine 1 is the predetermined heavy load work such as the excavation work or the lifting and slewing work, and the manipulation amount of the manipulation received by the manipulation device is the maximum value (in a case of the full lever manipulation), the exempted condition is satisfied by performing the horsepower control (YES in step S3 of FIG. 6), and the controller 70 performs the heavy load control (step S5). In this heavy load control, the controller 70 adjusts the engine rotation speed N to the base rotation speed N1.

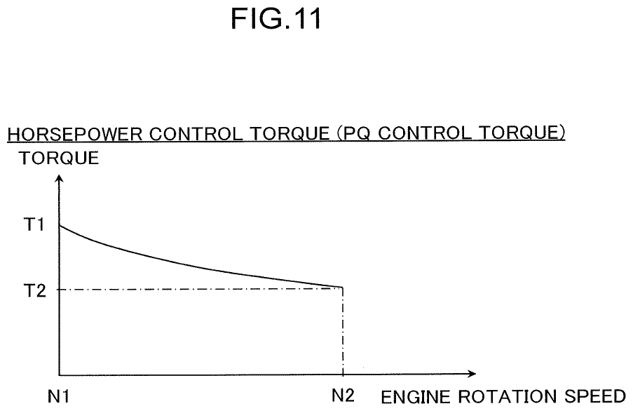

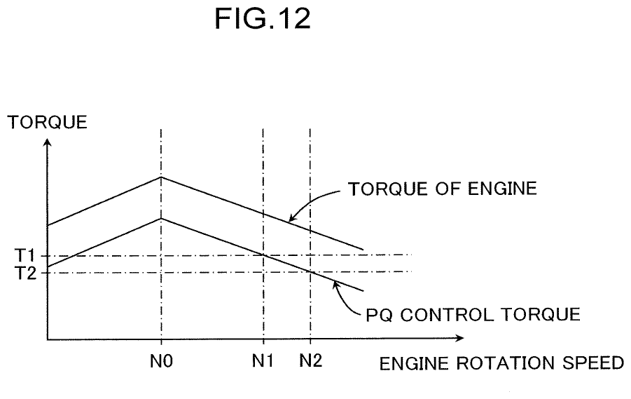

FIG. 11 is a graph illustrating a relationship between the engine rotation speed and a horsepower control torque (PQ control torque). As illustrated in FIG. 11, in the present embodiment, the horsepower control torque (PQ control torque) in the heavy load control, i.e., a horsepower control torque T1 at the base rotation speed N1 is larger than a horsepower control torque T2 at the standard rotation speed N2. In other words, a characteristic of the horsepower control torque is set so that the horsepower control torque increases from T2 to T1 when the engine rotation speed decreases from the standard rotation speed N2 to the base rotation speed N1. This will be described with reference to FIG. 12.

FIG. 12 is a graph illustrating a torque characteristic in the horsepower control (PQ control) and a torque characteristic of the engine 5. In the present embodiment, the torque characteristic of the engine 5 has such a characteristic that the torque is maximized when the engine rotation speed is “NO” and decreases as the engine rotation speed increases from NO. The engine rotation speed NO is a value smaller than the base rotation speed N1. The torque characteristic in the horsepower control has such a characteristic that the horsepower control torque increases or decreases so as to correspond to an increase or decrease of the torque in the torque characteristic of the engine 5, and the horsepower control torque is smaller than the torque of the engine 5 when compared at the same engine rotation speed. In the present embodiment, since each of the base rotation speed NI and the standard rotation speed N2 is set to a value larger than the rotation speed NO, when the engine rotation speed decreases from the standard rotation speed N2 to the base rotation speed N1, the horsepower control torque can be increased from T2 to T1.

The reason why the torque characteristic in the horsepower control is set so that the horsepower control torque is smaller than the torque of the engine 5 when compared at the same engine rotation speed is as follows. That is, when the horsepower control is performed, an unavoidable sudden change in a load may occur, and a pump pressure may rapidly increase accordingly. In such a case, it is necessary to perform control to reduce the pump capacity in order to maintain the horsepower control torque in the horsepower control within a range smaller than the torque of the engine 5. However, when the control of the pump capacity is not in time, there is a possibility that the horsepower control torque transiently exceeds the torque of the engine 5 to cause an engine stall. In order to prevent such a problem from occurring, a torque characteristic in the horsepower control is set such that the horsepower control torque is smaller than the torque of the engine 5.

In the present embodiment, as described above, the torque characteristic in the horsepower control has such a torque characteristic that the horsepower control torque at the base rotation speed N1 is larger than the horsepower control torque at the standard rotation speed N2, which is the engine rotation speed higher than the base rotation speed N1. When the torque in the horsepower control increases, a pump flow rate in a horsepower control range is easily secured. Therefore, it is possible to secure a workload in the heavy load work while improving fuel efficiency in the heavy load work.

The pump capacity in the horsepower control can be decided using the following equation (2).

T=q×P/2π (2)
T: horsepower control torque
q: pump capacity
P: pump pressure

A pump flow rate Q2 at the standard rotation speed N2 is expressed by the following equation (3).

Q2=T2×(2π/P)×N2 (3)
Q2: pump flow rate at standard rotation speed N2
T2: horsepower control torque
P: pump pressure

A pump flow rate Q1 at the base rotation speed N1 is expressed by the following equation (4).

Q1=T1×(2π/P)×N1 (4)
Q1: pump flow rate at base rotation speed N1
T1: horsepower control torque
P: pump pressure

In the heavy load control, when the engine rotation speed is decreased from the standard rotation speed N2 to the base rotation speed N1 and the horsepower control torque is increased from T2 to T1, the following equation (5) is preferably satisfied.

T1×N1=T2×N2 (5)

Since horsepower is proportional to a product of a torque and an engine rotation speed, when the above equation (5) is satisfied, the same horsepower as that before the decrease in the engine rotation speed can be obtained even when the engine rotation speed decreases from the standard rotation speed N2 to the base rotation speed N1 in the heavy load control.

In a case where the above equation (5) is satisfied, the following equation (6) is also satisfied.

Q2=T2×(2π/P)×N2=T1×(2π/P)×N1 (6)

Therefore, when a load (pump pressure P) is the same, the pump flow rate Q2 becomes the same value at the pump flow rate Q1. This makes it possible to obtain the same pump flow rate as that before the decrease of the engine rotation speed even when the engine rotation speed decreases from the standard rotation speed N2 to the base rotation speed N1 in the heavy load control, and makes it possible to improve fuel efficiency by decreasing the engine rotation speed while securing a workload in the predetermined heavy load work such as the excavation work or the lifting and slewing work.

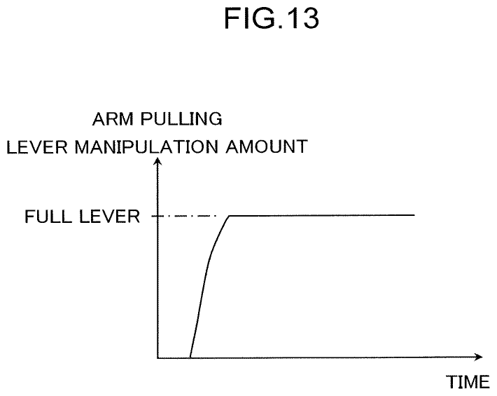

With regard to the above embodiment, a case where the predetermined light load work is the horizontal pulling and leveling work and the predetermined heavy load work is the excavation work is taken as a specific example, and more detailed description will be made of the specific example below with reference to FIGS. 13 to 18.

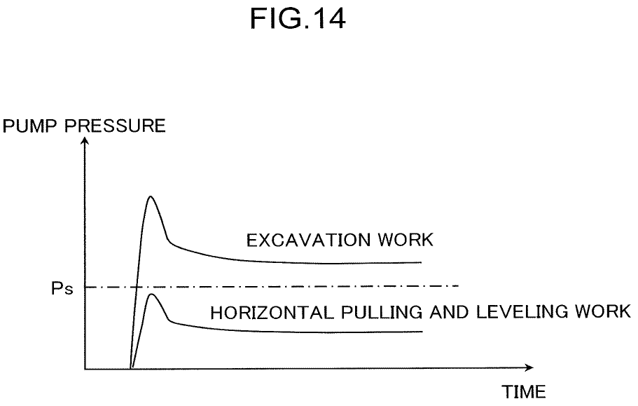

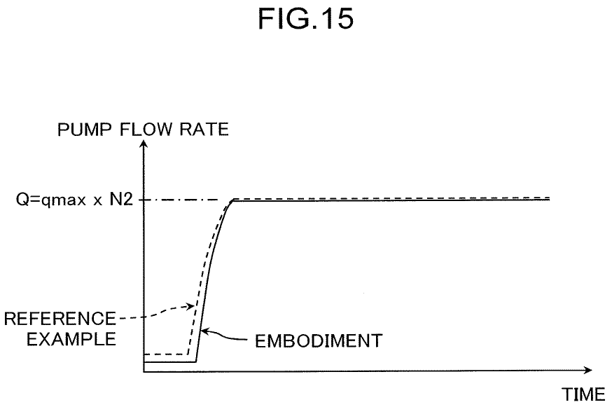

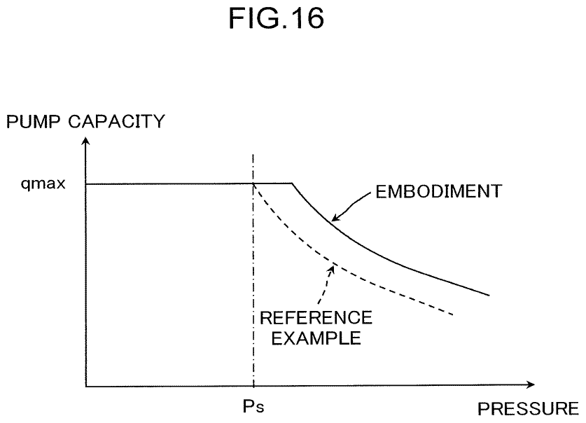

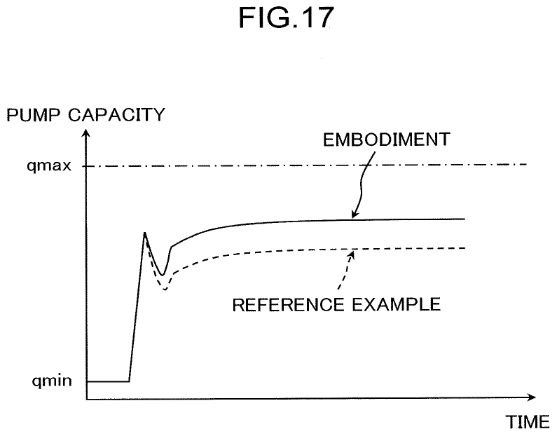

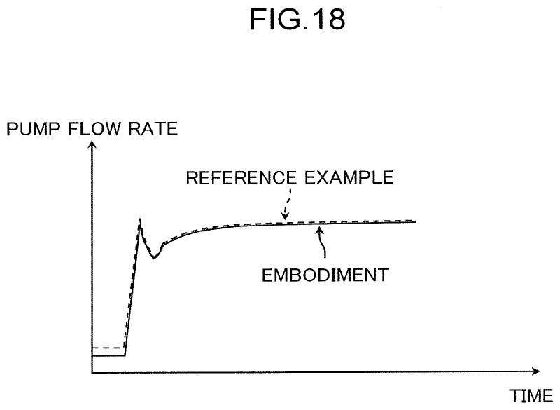

FIG. 13 is a graph illustrating an example of a temporal change in a manipulation amount of the arm pulling manipulation received by the manipulation device in each of the horizontal pulling and leveling work and the excavation work. FIG. 14 is a graph illustrating an example of a temporal change in a pump pressure in each of the horizontal pulling and leveling work and the excavation work. FIG. 15 is a graph illustrating an example of a temporal change in a pump flow rate in the horizontal pulling and leveling work. FIG. 16 is a graph illustrating an example of a relationship between a pump pressure and a pump capacity in the excavation work. FIG. 17 is a graph illustrating an example of a temporal change in the pump capacity in the excavation work. FIG. 18 is a graph illustrating an example of a temporal change in a pump flow rate in the excavation work.

As illustrated in FIG. 13, in both a case where the construction machine 1 performs the horizontal pulling and leveling work and a case where the construction machine 1 performs the excavation work, the manipulation device receives the arm pulling manipulation. FIG. 13 illustrates a case where a manipulation amount of the arm pulling manipulation is the maximum value (a full lever manipulation amount).

Since the horizontal pulling and leveling work is the predetermined light load work and the excavation work is the predetermined heavy load work, the pump pressure becomes a high pressure in the excavation work and becomes a low pressure in the horizontal pulling and leveling work as illustrated in FIG. 14. Specifically, a pump pressure in the excavation work mainly transitions in the high pressure region (the PQ region) equal to or higher than the set pressure Ps, and a pump pressure in the horizontal pulling and leveling work mainly transitions in the low pressure region lower than the set pressure Ps. Therefore, the controller 70 performs the horsepower control (the PQ control) in the excavation work and performs the positive control in the horizontal pulling and leveling work.

In the horizontal pulling and leveling work (the predetermined light load work), the controller 70 performs the light load control, and increases the engine rotation speed according to the manipulation amount (the lever manipulation amount) of the arm pulling manipulation, for example. In a case where the manipulation device receives the arm pulling manipulation of the full lever manipulation amount as illustrated in FIG. 13, the engine rotation speed increases from the base rotation speed N1 to the standard rotation speed N2 as illustrated in FIG. 9. In addition, in a case where in the positive control, the manipulation amount is the full lever manipulation amount, the pump capacity becomes the maximum capacity qmax as illustrated in FIG. 7, and thus the pump flow rate Q becomes “Q=qmax×N2” as indicated by a solid line in FIG. 15.

In FIG. 15, a temporal change of the pump flow rate when control according to a reference example is performed is indicated by a broken line. This reference example is different from the light load control according to the present embodiment described above in that the engine rotation speed before the start of the horizontal pulling and leveling work is the standard rotation speed N2, and the engine rotation speed is maintained at the standard rotation speed N2 even after the start of the horizontal pulling and leveling work. Also in this reference example, when the positive control is performed in the horizontal pulling and leveling work and the manipulation amount of the arm pulling manipulation is the full lever manipulation amount, the pump capacity becomes the maximum capacity qmax as illustrated in FIG. 7, and the pump flow rate Q becomes “Q=qmax×N2” as indicated by a broken line in FIG. 15.

In the light load control according to the present embodiment, as indicated by the solid line in FIG. 15, a pump flow rate in an initial stage when the arm pulling manipulation is started in the horizontal pulling and leveling work, i.e., the pump flow rate in the initial stage until the engine rotation speed increases from the base rotation speed N1 according to the manipulation amount to reach the standard rotation speed N2 is slightly lower than that in the reference example. However, the pump flow rate in the present embodiment is equivalent to the pump flow rate in the reference example after the engine rotation speed reaches the standard rotation speed N2. Therefore, when compared in the entire horizontal pulling and leveling work, the light load control according to the present embodiment can obtain the same workload (workability) as that of the reference example. Note that since a fuel consumption amount is relatively small in the predetermined light load work, the light load control according to the present embodiment prioritizes securing of the workload rather than improvement of the fuel efficiency.

Next, the excavation work will be described. In the excavation work (the predetermined heavy load work), the controller 70 performs the heavy load control and adjusts the engine rotation speed to the base rotation speed N1. In the specific example of FIG. 9, since the engine rotation speed is the base rotation speed N1 even before the time t1 at which the excavation work is started, the controller 70 performs control to maintain the engine rotation speed at the base rotation speed N1 when the excavation work is started.

As illustrated in FIG. 14, although the pump pressure immediately after the start of the excavation work is lower than the set pressure Ps, when the pump pressure becomes equal to or higher than the set pressure Ps, the pump capacity becomes smaller than the maximum capacity qmax by the horsepower control illustrated in FIG. 8 even when the manipulation device receives the arm pulling manipulation of the full lever manipulation amount. On the other hand, as illustrated in FIG. 11, the horsepower control torque T1 in a case where the engine rotation speed is the base rotation speed N1 is larger than the horsepower control torque T2 in a case where the engine rotation speed is the standard rotation speed N2 (T1>T2). As indicated by the above equation (2), when the horsepower control torque increases, the pump capacity also increases. Therefore, when compared at the same pump pressure, the pump capacity in the heavy load control according to the present embodiment indicated by a solid line in FIG. 16 is larger than the pump capacity in the horsepower control according to the reference example indicated by a broken line in FIG. 16. As a result, as illustrated in FIG. 17, in almost the entire excavation work, the pump capacity (solid line) in the heavy load control according to the embodiment is larger than the pump capacity (broken line) in the control according to the reference example.

As shown in FIG. 9, the base rotation speed N1, which is the engine rotation speed in the heavy load control according to the present embodiment, is lower than the standard rotation speed N2 (the engine rotation speed in the control according to the reference example). However, as shown in FIG. 17, the pump capacity (solid line) in the present embodiment is larger than the pump capacity (broken line) in the reference example. The pump flow rate is proportional to a product of the pump capacity and the engine rotation speed as shown in the above equation (1). Therefore, in the heavy load control according to the present embodiment, in a case where a torque characteristic is set so that the above equation (5) is satisfied when the engine rotation speed is decreased from the standard rotation speed N2 to the base rotation speed N1 and the horsepower control torque is increased from T2 to T1, a pump flow rate (solid line) in the present embodiment is equivalent to a pump flow rate (broken line) in the reference example as illustrated in FIG. 18. As a result, in the heavy load control according to the present embodiment, it is possible to improve fuel efficiency while securing a workload by securing a pump flow rate.

Although in the above specific example described with reference to FIGS. 13 to 18, the predetermined light load work is the horizontal pulling and leveling work and the predetermined heavy load work is the excavation work, the same effect as the above specific example can be obtained also in a case where the predetermined light load work is other work such as the soil discharging work, and the same effect as the above specific example can be obtained also in a case where the predetermined heavy load work is other work such as the lifting and slewing work.

As described in the foregoing, in the hydraulic control device, the construction machine 1, and the control method for the construction machine 1 according to the present embodiment, the engine rotation speed is adjusted to the predetermined base rotation speed when the work by the construction machine is the predetermined heavy load work, and the engine rotation speed is made higher than the base rotation speed when the work by the construction machine is the predetermined light load work. As a result, fuel efficiency in the predetermined heavy load work can be improved, and a workload in the predetermined light load work can be secured.

While the embodiment of the present disclosure has been described in the foregoing, the present disclosure is not limited to the embodiment, and includes the following modifications, for example.

### (A) First Modification

In the above embodiment, although the exempted condition includes at least one of the conditions (a) to (c), the exempted condition may include the following condition (d). That is, the exempted condition may include at least one of the conditions (a) to (d). The condition (d) is that predetermined regenerative control is performed.

The predetermined regenerative control may be, for example, control of supplying the hydraulic oil discharged from the boom cylinder 9 having a load lower than that of the arm cylinder 10 to the arm cylinder 10 when the manipulation device simultaneously receives the boom lowering manipulation for causing the boom 6 to perform the boom lowering operation and the arm pushing manipulation for causing the arm 7 to perform the arm pushing operation. The boom lowering manipulation is an example of first manipulation in the present disclosure, and the arm pushing manipulation is an example of second manipulation in the present disclosure.

In a case where this regenerative control is performed, since the hydraulic oil discharged from the boom cylinder 9 having the load lower than that of the arm cylinder 10 is supplied to the arm cylinder 10, it is possible to secure a supply amount of the hydraulic oil to the arm cylinder 10 even when the engine rotation speed is low (e.g., even when the engine rotation speed is the base rotation speed N1). Therefore, in a case where the manipulation device receives the predetermined manipulation (YES in step S2) and the exempted condition is satisfied by performing the regenerative control (YES in step S3), the controller 70 performs the heavy load control (step S5) instead of the light load control (step S4). As a result, it is possible to improve the fuel efficiency while securing the supply amount of the hydraulic oil to the arm cylinder 10.

In addition, in this modification, as described with reference to FIG. 11, the horsepower control torque T1 in a case where the engine rotation speed is the base rotation speed N1 is preferably larger than the horsepower control torque T2 in a case where the engine rotation speed is the standard rotation speed N2 (T1>T2). In this case, in the heavy load control according to the modification, it is possible to improve fuel efficiency while securing a workload by securing a pump flow rate.

The controller 70 may determine whether or not to perform the regenerative control by determining whether or not the manipulation device simultaneously receives the boom lowering manipulation and the arm pushing manipulation. That is, the controller 70 may determine whether or not to perform the regenerative control on the basis of detection results by the pressure sensors P6, P7, P8, and P9. In addition to determining whether or not the manipulation device simultaneously receives the boom lowering manipulation and the arm pushing manipulation, the controller 70 may determine whether or not the pressure acting on the head side chamber of the boom cylinder 9 is higher than the pressure acting on the rod side chamber of the arm cylinder 10, and determine to perform the regenerative control when these determination conditions are satisfied.

As a specific example of the work in which the manipulation device simultaneously receives the boom lowering manipulation and the arm pushing manipulation, for example, return work can be exemplified. The return work is often performed after the soil discharging work. Specifically, the construction machine 1 performs a series of works including the excavation work of excavating an excavation target such as earth and sand of the ground with the bucket 8, the lifting and slewing work of moving the bucket 8 holding a holding object such as earth and sand to directly above a soil discharging destination such as a cargo bed of a truck, the soil discharging work of discharging the holding object held by the bucket 8 directly above the soil discharging destination to the soil discharging destination, and the return work of moving the bucket 8 from directly above the soil discharging destination to the excavation target. When the construction machine 1 performs the return work, the manipulation device receives the boom lowering manipulation, the arm pushing manipulation, and the slewing manipulation by the operator, the boom 6 performs the boom lowering operation, the arm 7 performs the arm pushing operation, and the upper slewing body 3 performs the slewing operation.

An example of the hydraulic circuit 12 capable of performing the regenerative control (valve regenerative control) as described above will be briefly described with reference to FIG. 2. As illustrated in FIG. 2, the hydraulic circuit 12 includes a regenerative oil passage y7 that connects the oil passage y4 and the oil passage y5. A regenerative valve 22 is disposed in the regenerative oil passage y7. The regenerative valve 22 is a switching valve that can be switched between a supply position (a position illustrated in FIG. 2) at which hydraulic oil can be supplied from the oil passage y4 to the oil passage y5 and a prohibited position (an upper position in FIG. 2) at which the oil passage y4 and the oil passage y5 are blocked from each other. The regenerative valve 22 is normally opened, and may be configured to operate to close by a pilot pressure from an electromagnetic proportional valve b2. In this case, the electromagnetic proportional valve b2 operates according to an electric signal from an amplifier a2. The amplifier a2 may be controlled by the controller 70. When the regenerative valve 22 is manipulated to the allowable position, the hydraulic oil led out from the head side chamber of the boom cylinder 9 can be guided to the rod side chamber of the arm cylinder 10. In addition, the regenerative valve 22 may be configured to be able to adjust a flow rate of the hydraulic oil flowing through the regenerative oil passage y7 according to a manipulation stroke between the allowable position and the prohibited position.

Furthermore, the exempted condition may include, for example, that engine speed sensing control (ESS control) is performed. The ESS control is control for adjusting the pump flow rate of the pump device 15 according to a difference between a target rotation speed and an actual rotation speed of the engine 5.

### (B) Second Modification

In the construction machine 1 according to a second modification, the controller 70 suspends execution of the engine rotation speed control in at least one of a case (case 1) where the manipulation device receives the travelling manipulation, a case (case 2) where the manipulation device receives predetermined optional manipulation, a case (case 3) where the construction machine 1 is subjected to automatic control or semi-automatic control, and a case (case 4) where the engine rotation speed is equal to or lower than a predetermined rotation speed lower than the base rotation speed N1. By suspending the execution of the engine rotation speed control, it is possible to control the engine rotation speed suitable for each of these cases without having the engine rotation speed control restricted.

Specifically, in any of the cases 1 to 4, the controller 70 may determine that the control mode is not the engine rotation speed control mode (NO in step S1), and adjust the engine rotation speed to the standard rotation speed N2 in the normal control (step S6).

[Case 1] Travelling work performed by the construction machine 1 when the manipulation device receives the travelling manipulation requires a relatively high pump flow rate. Therefore, in the case 1, the controller 70 preferably adjusts the engine rotation speed to the standard rotation speed N2, for example. This enables a workload to be secured in the travelling work.

[Case 2] An optional device (not illustrated) different from the bucket 8 may be attached to the distal end of the arm 7. The optional device may be, for example, a tip attachment having a function of gripping an object such as a grapple or a fork, may be a tip attachment having a function of crushing an object such as a crusher, or may be a tip attachment having another function. The predetermined optional manipulation is manipulation given to the manipulation device to exhibit the function of the optional device as described above. The optional work performed by the construction machine 1 when the manipulation device receives the optional manipulation requires a relatively large pump flow rate. Therefore, in the case 2, the controller 70 preferably adjusts the engine rotation speed to the standard rotation speed N2, for example. This enables a workload to be secured in the optional work.

[Case 3] The construction machine 1 may be subjected to machine control (automatic control or semi-automatic control) by the controller 70. In this case, the controller 70 may be a part of the construction machine 1, or may constitute a part or the entire of the hydraulic control device disposed at a place different from the construction machine 1. In this case, the controller 70 sets the control mode to a machine control mode instead of the engine rotation speed control mode. In the machine control mode, the engine rotation speed is less varied than in the engine rotation speed control mode. This enables more accurate operation in the machine control.

[Case 4] The predetermined rotation speed is a value smaller than the base rotation speed N1, and may be, for example, the rotation speed N0 in FIG. 12. Specifically, the case 4 may be a case in which the standard rotation speed is set to the rotation speed NO. In such a case, the base rotation speed becomes a value further smaller than the rotation speed NO as the standard rotation speed, and in the torque characteristic illustrated in FIG. 12, when the engine rotation speed decreases from N0 as the standard rotation speed to the base rotation speed, the horsepower control torque also decreases. In this case, it is not possible to perform the control in the above embodiment to increase the horsepower control torque from T2 to T1 when the engine rotation speed decreases from the standard rotation speed N2 to the base rotation speed N1. In this case, in the case 4, a workload in the heavy load control may not be sufficiently secured. Therefore, in the case 4, the controller 70 may determine that the control mode is not the engine rotation speed control mode (NO in step S1), and adjust the engine rotation speed to the standard rotation speed N2 in the normal control (step S6) to secure a workload. Note that the construction machine 1 may include an accelerator (not illustrated) manipulatable by the operator, and the standard rotation speed may be set by the operator manipulating the accelerator.

### (C) Third Modification

When an amount of the bucket 8 entering the ground (penetration amount) during the excavation work is reduced, the horsepower control may be switched to the positive control. In such a case, the state in which the exempted condition is satisfied (YES in step S3 of FIG. 6) is changed to the state in which the exempted condition is not satisfied (NO in step S3), and the engine rotation speed may increase or rapidly increase from the base rotation speed N1 toward the standard rotation speed N2. When the pump flow rate rapidly increases due to this, an operation speed of the work device 4 may fluctuate, leading to deterioration of operability of the operator.

In order to solve this problem, in the construction machine 1 according to the third modification, the controller 70 performs control for suppressing an increasing speed of an engine rotation speed when the heavy load control is switched to the light load control. In the third modification, it is possible to suppress occurrence of a sudden change in the engine rotation speed when the heavy load control is switched to the light load control. As a result, it is possible to suppress a decrease in operability of the operator due to a sudden change in the engine rotation speed, and it is possible to suppress the operator from feeling discomfort due to a sudden change in the engine rotation speed.

In the third modification, when switching the heavy load control to the light load control, the controller 70 may perform transient change suppression processing such as a rate limiter on a change of a target value of the engine rotation speed (e.g., change from the target rotation speed N1 to the target rotation speed N2). The change suppression processing may be, for example, adjusting a change speed of the rotation speed from the target rotation speed N1 to the target rotation speed N2 to a predetermined speed or to a speed lower than a predetermined speed. As a result, when the heavy load control is switched to the light load control, the change speed of the engine rotation speed decreases, so that deterioration of operability of the operator can be suppressed.

### (D) Fourth Modification

The construction machine 1 may be configured to be remotely manipulated. In this case, the manipulation device may be disposed at a place (remote location) different from the construction machine 1. In addition, the controller 70 may be a part of the construction machine 1, may be disposed at a remote place, or may be disposed at a place different from the construction machine 1 and the manipulation device.

As described above, according to the present disclosure, there are provided a hydraulic control device, a construction machine, and a control method for a construction machine that enable improvement of fuel efficiency in heavy load work and securing of a workload in light load work.

A hydraulic control device according to a first aspect is a hydraulic control device for a construction machine including a work device, at least one actuator that operates the work device, a pump device that supplies hydraulic oil to the at least one actuator, and an engine that drives the pump device, the hydraulic control device including a manipulation device that receives manipulation for operating the work device, and a controller. The controller performs engine rotation speed control including heavy load control of adjusting an engine rotation speed to a predetermined base rotation speed when work by the construction machine is predetermined heavy load work, and light load control of making the engine rotation speed be higher than the base rotation speed when the work by the construction machine is predetermined light load work.

In the first aspect, when the work of the construction machine is heavy load work such as excavation work and lifting and slewing work, the engine rotation speed is adjusted to the base rotation speed, so that fuel efficiency in the heavy load work can be improved. On the other hand, since when the work of the construction machine is light load work such as leveling work and soil discharging work, the engine rotation speed is adjusted so that the engine rotation speed becomes higher than the base rotation speed, a workload in the light load work can be secured,

In the light load control, the controller may uniformly adjust the engine rotation speed to, for example, a constant value larger than that of the base rotation speed regardless of a manipulation amount of the manipulation. However, it is preferable to adjust the engine rotation speed as in the following second aspect. That is, according to the second aspect, the hydraulic control device according to the first aspect preferably further includes the following feature. In the hydraulic control device according to the second aspect, the controller preferably adjusts the engine rotation speed so that the engine rotation speed increases from the base rotation speed according to a manipulation amount of the manipulation in the light load control. In the second aspect, as compared with a case where the engine rotation speed is uniformly adjusted to the constant value regardless of the manipulation amount of the manipulation in the light load control, the engine rotation speed can be gradually increased according to the manipulation amount. This enables suppression of occurrence of a sudden change in the engine rotation speed when the light load control is started.

A third aspect may further include the following feature in the hydraulic control device according to the first or second aspect. That is, in the hydraulic control device according to the third aspect, the controller may perform the light load control when the manipulation device receives predetermined manipulation for determining whether or not the work by the construction machine is the light load work. In other words, the controller may determine that the work by the construction machine is the light load work when the manipulation device receives predetermined manipulation. The predetermined manipulation may be stored in the controller in advance as manipulation received by the manipulation device when the light load work is performed. Specifically, for example, in a case where the work device includes a boom, an arm, and a bucket, the predetermined manipulation may include, for example, at least one manipulation of arm pushing manipulation, arm pulling manipulation, and bucket soil discharging manipulation. In this case, the controller may perform the light load control when the manipulation device receives the at least one manipulation (i.e., the predetermined manipulation).

In a fourth aspect, the hydraulic control device according to the third aspect preferably further includes the following feature. That is, in the hydraulic control device according to the fourth aspect, the controller preferably suspends execution of the light load control in a case where a predetermined exempted condition is satisfied even when the manipulation device receives the predetermined manipulation. In the fourth aspect, not only the predetermined manipulation but also the predetermined exempted condition is used as an index for determining whether or not the work by the construction machine is the light load work, so that determination accuracy of whether or not the work by the construction machine is the light load work (i.e., determination accuracy as to whether or not to execute the light load control) is improved. In the fourth aspect, even in a case where the manipulation device receives the predetermined manipulation, the controller may perform the heavy load control instead of performing the light load control when the predetermined exempted condition is satisfied.

A fifth aspect may further include the following feature in the hydraulic control device according to the fourth aspect. That is, in the hydraulic control device according to the fifth aspect, the predetermined exempted condition preferably includes at least one of that a load acting on the at least one actuator is equal to or more than a predetermined first set value, that a pump pressure of the pump device is equal to or more than a predetermined second set value, and that horsepower control is performed, and in a case where the predetermined exempted condition is satisfied even when the manipulation device receives the predetermined manipulation, the controller preferably performs the heavy load control instead of performing the light load control. In a case where the load acting on the at least one actuator is equal to or more than the predetermined first set value, in a case where the pump pressure of the pump device is equal to or more than the predetermined second set value, and in a case where the horsepower control is performed, there is a high possibility that the work of the construction machine is heavy load work. Therefore, in the fifth aspect, even in a case where the manipulation device receives the predetermined manipulation, when the predetermined exempted condition is satisfied, the heavy load control is performed instead of the light load control, thereby improving fuel efficiency in the heavy load work.

In a sixth aspect, the hydraulic control device according to the fourth or fifth aspect preferably further includes the following feature. That is, in the hydraulic control device according to the sixth aspect, the work device preferably includes a first movable part and a second movable part, the at least one actuator preferably includes a first actuator that operates the first movable part and a second actuator that operates the second movable part, the predetermined exempted condition preferably includes that predetermined regenerative control is performed, the regenerative control being control to supply hydraulic oil discharged from the first actuator having a load lower than that of the second actuator to the second actuator when the manipulation device simultaneously receives predetermined first manipulation for operating the first movable part and predetermined second manipulation for operating the second movable part, and in a case where the predetermined exempted condition is satisfied even when the manipulation device receives the predetermined manipulation, the controller preferably performs the heavy load control instead of performing the light load control. When the regenerative control as described above is performed, the hydraulic oil discharged from the first actuator having a load lower than that of the second actuator is supplied to the second actuator. Therefore, even when the engine rotation speed is low (i.e., even when the engine rotation speed is the base rotation speed), a supply amount of the hydraulic oil to the second actuator can be secured. Accordingly, in the sixth aspect, since even in a case where the manipulation device receives the predetermined manipulation, when the exempted condition is satisfied, the controller performs the heavy load control instead of performing the light load control, so that fuel efficiency can be improved while ensuring the supply amount of the hydraulic oil.

In a seventh aspect, the hydraulic control device according to any one of the first to sixth aspects preferably further includes the following feature. That is, the hydraulic control device according to the seventh aspect preferably has such a torque characteristic that a torque at the base rotation speed is larger than a torque at an engine rotation speed higher than the base rotation speed. In the seventh aspect, in a case where the heavy load control in which the engine rotation speed is adjusted to the base rotation speed is executed, a horsepower control torque at the base rotation speed is larger than a horsepower control torque at the engine rotation speed higher than the base rotation speed. When the torque in the horsepower control increases, a pump flow rate in a horsepower control range is easily secured. Therefore, in the seventh aspect, it is possible to secure a workload in the heavy load work while improving fuel efficiency in the heavy load work.

In an eighth aspect, the hydraulic control device according to any one of the first to seventh aspects preferably further includes the following feature. That is, in the hydraulic control device according to the eighth aspect, the controller preferably suspends execution of the engine rotation speed control in at least one of a case where the manipulation device receives travelling manipulation, a case where the manipulation device receives predetermined optional manipulation, a case where the construction machine is subjected to automatic control or semi-automatic control, and a case where the engine rotation speed is equal to or lower than a predetermined rotation speed lower than the base rotation speed. By suspending the execution of the engine rotation speed control, it is possible to control the engine rotation speed suitable for each of these cases without having the engine rotation speed control restricted.

In a ninth aspect, the hydraulic control device according to any one of the first to eighth aspects preferably further includes the following feature. That is, in the hydraulic control device according to the ninth aspect, the controller preferably performs control for suppressing an increasing speed of the engine rotation speed when switching the heavy load control to the light load control. In the ninth aspect, it is possible to suppress occurrence of a sudden change in the engine rotation speed when the heavy load control is switched to the light load control. As a result, it is possible to suppress a decrease in operability of the operator due to a sudden change in the engine rotation speed, and it is possible to suppress the operator from feeling discomfort due to a sudden change in the engine rotation speed.

A construction machine according to a tenth aspect includes a work device, at least one actuator that operates the work device, a pump device that supplies hydraulic oil to the at least one actuator, an engine that drives the pump device, and the hydraulic control device according to any one of the first to ninth aspects.

A control method for a construction machine according to an eleventh aspect is a control method for controlling a construction machine including a work device, at least one actuator that operates the work device, a pump device that supplies hydraulic oil to the at least one actuator, and an engine that drives the pump device, the control method including: adjusting an engine rotation speed to a predetermined base rotation speed when work by the construction machine is predetermined heavy load work, and making the engine rotation speed be higher than the base rotation speed when the work by the construction machine is predetermined light load work. In the eleventh aspect, when the work of the construction machine is heavy load work such as the excavation work and the lifting and slewing work, the engine rotation speed is adjusted to the base rotation speed, so that fuel efficiency in the heavy load work can be improved. On the other hand, since when the work of the construction machine is light load work such as leveling work and soil discharging work, the engine rotation speed is adjusted so that the engine rotation speed becomes higher than the base rotation speed, a workload in the light load work can be secured.

1. A hydraulic control device for a construction machine including a work device, at least one actuator that operates the work device, a pump device that supplies hydraulic oil to the at least one actuator, and an engine that drives the pump device, the hydraulic control device comprising:
a manipulation device that receives manipulation for operating the work device; and
a controller that performs engine rotation speed control including heavy load control of adjusting an engine rotation speed to a predetermined base rotation speed when work by the construction machine is predetermined heavy load work, and light load control of making the engine rotation speed be higher than the base rotation speed when the work by the construction machine is predetermined light load work.

2. The hydraulic control device according to claim 1, wherein the controller adjusts the engine rotation speed so that the engine rotation speed increases from the base rotation speed according to a manipulation amount of the manipulation in the light load control.

3. The hydraulic control device according to claim 1, wherein the controller performs the light load control when the manipulation device receives predetermined manipulation for determining whether or not the work by the construction machine is the predetermined light load work.

4. The hydraulic control device according to claim 3, wherein the controller suspends execution of the light load control in a case where a predetermined exempted condition is satisfied even when the manipulation device receives the predetermined manipulation.

5. The hydraulic control device according to claim 4, wherein
the predetermined exempted condition includes at least one of that a load acting on the at least one actuator is equal to or more than a predetermined first set value, that a pump pressure of the pump device is equal to or more than a predetermined second set value, and that horsepower control is performed, and
in a case where the predetermined exempted condition is satisfied even when the manipulation device receives the predetermined manipulation, the controller performs the heavy load control instead of performing the light load control.

6. The hydraulic control device according to claim 4, wherein
the work device includes a first movable part and a second movable part,
the at least one actuator includes a first actuator that operates the first movable part and a second actuator that operates the second movable part,
the predetermined exempted condition includes that predetermined regenerative control is performed, the regenerative control being control to supply hydraulic oil discharged from the first actuator having a load lower than that of the second actuator to the second actuator when the manipulation device simultaneously receives predetermined first manipulation for operating the first movable part and predetermined second manipulation for operating the second movable part, and
in a case where the predetermined exempted condition is satisfied even when the manipulation device receives the predetermined manipulation, the controller performs the heavy load control instead of performing the light load control.

7. The hydraulic control device according to claim 1, wherein the construction machine has such a torque characteristic that a torque at the base rotation speed is larger than a torque at an engine rotation speed higher than the base rotation speed.

8. The hydraulic control device according to claim 1, wherein the controller suspends execution of the engine rotation speed control in at least one of a case where the manipulation device receives travelling manipulation, a case where the manipulation device receives predetermined optional manipulation, a case where the construction machine is subjected to automatic control or semi-automatic control, and a case where the engine rotation speed is equal to or lower than a predetermined rotation speed lower than the base rotation speed.

9. The hydraulic control device according to any one of claim 1, wherein the controller performs control for suppressing an increasing speed of the engine rotation speed when switching the heavy load control to the light load control.

10. A construction machine comprising:
a work device;
at least one actuator that operates the work device;
a pump device that supplies hydraulic oil to the at least one actuator;
an engine that drives the pump device; and
the hydraulic control device according to claim 1.

11. A control method for controlling a construction machine including a work device, at least one actuator that operates the work device, a pump device that supplies hydraulic oil to the at least one actuator, and an engine that drives the pump device, the control method comprising:
adjusting an engine rotation speed to a predetermined base rotation speed when work by the construction machine is predetermined heavy load work, and making the engine rotation speed be higher than the base rotation speed when the work by the construction machine is predetermined light load work.
